(19) United States
(12) Patent Application Publication
(10) Pub. No.: US 2025/0276661 A1
(43) Pub. Date: Sep. 4, 2025

(54) VEHICLE FRONT STRUCTURE

(71) Applicant: TOYOTA JIDOSHA KABUSHIKI KAISHA, Toyota-shi (JP)

(72) Inventor: Toshiaki EGUCHI, Toyota-shi (JP)

(73) Assignee: TOYOTA JIDOSHA KABUSHIKI KAISHA, Toyota-shi (JP)

(21) Appl. No.: 18/967,684

(22) Filed: Dec. 4, 2024

(30) Foreign Application Priority Data
Feb. 29, 2024 (JP) 2024-029716

(51) Int. Cl. B60R 19/48

(52) U.S. Cl. CPC B60R 19/483; B60R 2019/486

(57) ABSTRACT

The vehicle front structure includes a front bumper cover having an opening, and a millimeter wave radar and a camera disposed in a region corresponding to the opening. The vehicle front structure includes a cover member disposed on the vehicle front side with respect to the millimeter-wave radar and the camera and provided so as to cover the millimeter-wave radar and the camera, and an air guide member disposed on the vehicle rear side with respect to the millimeter-wave radar and the camera.

### CROSS-REFERENCE TO RELATED APPLICATION

This application claims priority to Japanese Patent Application No. 2024-029716 filed on Feb. 29, 2024, incorporated herein by reference in its entirety.

### BACKGROUND

### 1. Technical Field

The present disclosure relates to a vehicle front structure.

### 2. Description of Related Art

Conventionally, there has been known a vehicle front structure including a front bumper cover having an opening and a front grille provided in the opening (see Japanese Unexamined Patent Application Publication No. 2023-148542 (JP 2023-148542 A), for example).

In the vehicle front structure according to JP 2023-148542 A, a radar for detecting an obstacle located ahead of a vehicle is attached to the front grille.

### SUMMARY

Here, it is conceivable that a windshield cover member is provided so as to cover a sensor such as a radar when the sensor is attached to the front grille, as in the conventional vehicle front structure described above. When the windshield cover member is provided, the air flow is disturbed on the vehicle rear side of the cover member, which may deteriorate an air resistance coefficient.

The present disclosure has been made in order to address the above issue, and an object of the present disclosure is to provide a vehicle front structure capable of improving an air resistance coefficient.

An aspect of the present disclosure provides a vehicle front structure including a front bumper cover having an opening and a sensor disposed in a region corresponding to the opening.

The vehicle front structure includes: a cover member disposed on a vehicle front side with respect to the sensor and provided so as to cover the sensor; and an air guide member disposed on a vehicle rear side with respect to the sensor.

In the vehicle front structure,

the air guide member may be provided so as to extend from the cover member toward the vehicle rear side, and be inclined so as to be positioned downward toward the vehicle rear side when viewed from a side.

In the vehicle front structure,

the air guide member may be provided to have a width that becomes smaller toward the vehicle rear side when viewed in plan.

The vehicle front structure may further include

a front grille provided in the opening, and
the sensor may be attached to the front grille.

According to the vehicle front structure of the present disclosure, it is possible to improve an air resistance coefficient.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic front view of a vehicle to which a vehicle front structure of the present embodiment is applied;

FIG. 2 is a cross-sectional II-II view of FIG. 1; and

FIG. 3 is a cross-sectional III-III view of FIG. 1.

### DETAILED DESCRIPTION OF EMBODIMENTS

Hereinafter, an embodiment of the present disclosure will be described.

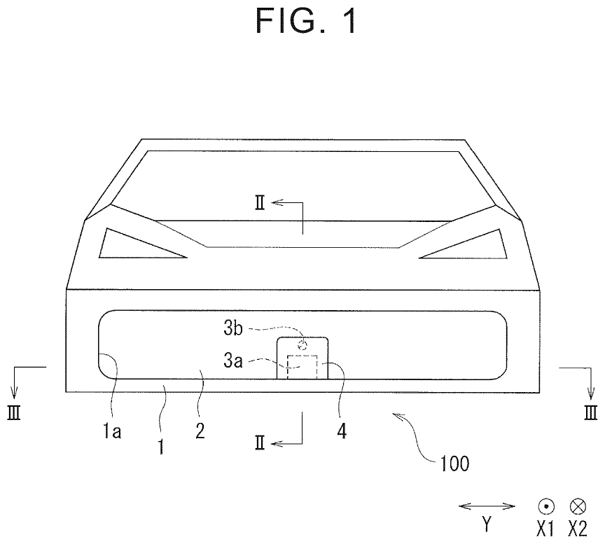

First, a vehicle front structure 100 according to an embodiment of the present disclosure will be described with reference to FIGS. 1 to 3.

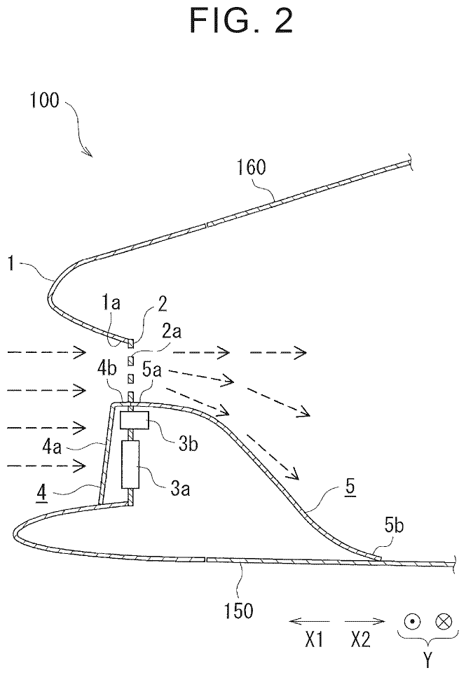

As illustrated in FIG. 2, the vehicle front structure 100 includes a front bumper cover 1, a front grille 2, a millimeter-wave radar 3a and a camera 3b, a cover member 4, and an air guide member 5. The vehicle front structure 100 is located at the front end of the engine compartment. An undercover 150 is provided at a lower end portion of the engine compartment, and a hood 160 is provided at an upper end portion of the engine compartment. In the drawings, the vehicle front side is X1 direction side, the vehicle rear side is X2 direction side, and the vehicle width direction is the Y direction.

As shown in FIG. 1, the front bumper cover 1 is disposed at a front end portion of the vehicle and is formed so as to extend in the vehicle width direction. The front bumper cover 1 has an opening 1a, and the opening 1a is formed so as to extend in the vehicle-width direction.

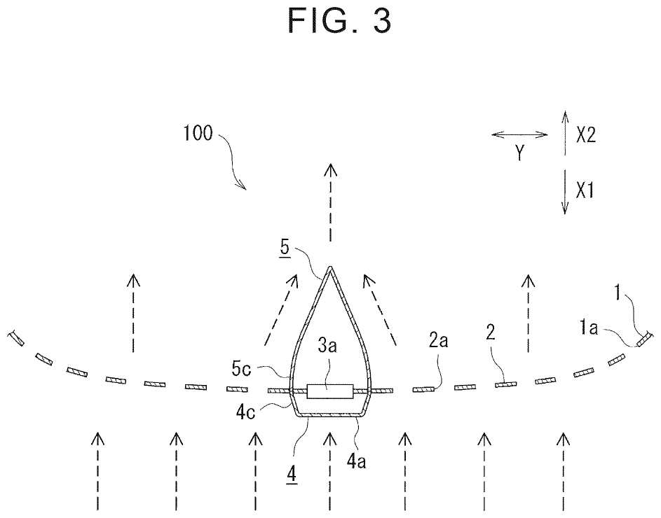

The front grille 2 is attached to the opening 1a and is provided so as to close the opening 1a. The front grille 2 is formed in, for example, a mesh shape or a grid shape, and has a plurality of opening 2a (see FIGS. 2 and 3) for allowing outside air to flow in. Note that, in FIG. 1, the opening 2a is not illustrated in view of visibility. The outside air is caused to flow into the engine compartment by a vehicle running or a fan (not shown).

The millimeter-wave radar 3a and the camera 3b are provided to acquire information in front of the vehicle. The millimeter-wave radar 3a and the information acquired by the camera 3b are used, for example, for driving assistance of vehicles. The millimeter-wave radar 3a and the camera 3b are disposed at a center portion in the vehicle-width direction and are attached to the front grille 2. Therefore, the millimeter-wave radar 3a and the camera 3b are arranged in an area corresponding to the opening 1a. Note that the millimeter-wave radar 3a and the camera 3b are exemplary “sensors” of the present disclosure.

The cover member 4 is for windshields and is configured to protect the millimeter-wave radar 3a and the camera 3b. As shown in FIGS. 2 and 3, the cover member 4 is disposed in front of the millimeter-wave radar 3a and the camera 3b and is provided so as to cover the millimeter-wave radar 3a and the camera 3b. The cover member 4 is configured to transmit millimeter waves and light.

Specifically, the cover member 4 has a front surface portion 4a, an upper surface portion 4b (see FIG. 2), and a side surface portion 4c (see FIG. 3). The front surface portion 4a is disposed closer to the vehicle front side than the millimeter-wave radar 3a and the camera 3b, and is disposed so as to intersect the vehicle front-rear direction. Therefore, the front surface portion 4a is disposed in an area corresponding to the millimeter-wave radar 3a and the camera 3b when viewed from the front side of the vehicle. The upper surface portion 4b is formed so as to extend from the upper end portion of the front surface portion 4a toward the rear of the vehicle. An end portion of the upper surface portion 4b on the rear side of the vehicle is connected to the front grille 2. The side surface portion 4c is formed so as to extend from the side end portion of the front surface portion 4a toward the rear side of the vehicle. The vehicle-rear end portion of the side surface portion 4c is connected to the front grille 2.

The air guide member 5 is provided to suppress the air flow being disturbed on the vehicle rear side of the cover member 4. That is, the air guide member 5 is provided to smooth the airflow of the cover member 4 on the vehicle rear side. The air guide member 5 is disposed behind the millimeter-wave radar 3a and the camera 3b and is provided so as to cover the millimeter-wave radar 3a and the camera 3b. Thus, the millimeter-wave radar 3a and the camera 3b are accommodated in the space defined by the cover member 4 and the air guide member 5.

Specifically, the air guide member 5 is formed to extend from the cover member 4 toward the vehicle rear side. An upper end portion 5a (see FIG. 2) of the air guide member 5 on the front side of the vehicle is connected to the front grille 2 and is provided so as to be continuous with the upper surface portion 4b of the cover member 4. The vehicle-rear-side end 5b (see FIG. 2) of the air guide member 5 is placed on the undercover 150. Therefore, when viewed from the side, the air guide member 5 is inclined so as to be positioned downward toward the vehicle rear side.

Further, the vehicle-front-side end portion 5c (see FIG. 3) of the air guide member 5 is connected to the front grille 2 and is provided so as to be continuous with the side surface portion 4c of the cover member 4. The air guide member 5 is formed so as to have a smaller width as it advances toward the vehicle rear side when viewed in a plan view. That is, the air guide member 5 is formed in a tapered shape when viewed in a plan view. That is, the air guide member 5 is connected at its side end portion on the vehicle rear side.

In FIG. 2 and FIG. 3, an example of the airflow is indicated by a dashed arrow. Among the outside air flowing from the opening 2a of the front grille 2, the air flowing around the cover member 4 is guided by the air guide member 5 so as to flow along the air guide member 5.

### Effects

In the present embodiment, as described above, by providing the air guide member 5, the air flow on the vehicle rear side of the cover member 4 is smoothed, it is possible to improve the air resistance coefficient.

Further, in the present embodiment, the air guide member 5 is provided so as to be inclined when viewed from the side, so that the air flow of the cover member 4 on the vehicle rear side can be smoothed.

Further, in the present embodiment, the air guide member 5 is formed in a tapered shape when viewed in a plan view, so that the air flow of the cover member 4 on the vehicle rear side can be smoothed.

### Other Embodiments

The embodiment disclosed here is exemplification in all respects and is not a basis for a limited interpretation. Accordingly, the technical scope of the disclosure is not interpreted only by the above embodiment but is defined based on the description in Claims. Further, all changes within the meaning and the scope equivalent to the claims are included in the technical scope of the disclosure.

For example, in the present embodiment, the vehicle front structure 100 may be applied to a sports car having a low vehicle height.

In the present embodiment, the millimeter-wave radar 3a and the camera 3b are attached to the front grille 2. The present disclosure is not limited thereto, and the millimeter wave radar and the camera may be disposed on the vehicle rear side with respect to the front grille.

Further, in the present embodiment, the millimeter-wave radar 3a and the camera 3b are provided. The present disclosure is not limited thereto, and only one of the millimeter wave radar and the camera may be provided, or sensors other than the millimeter wave radar and the camera may be provided. For example, a LiDAR sensor may be provided instead of or in addition to the millimeter-wave radar.

The present disclosure is applicable to a vehicle front structure including a front bumper cover having an opening and a sensor disposed in a region corresponding to the opening.

What is claimed is:

1. A vehicle front structure including a front bumper cover having an opening and a sensor disposed in a region corresponding to the opening, comprising:
a cover member disposed on a vehicle front side with respect to the sensor and provided so as to cover the sensor; and
an air guide member disposed on a vehicle rear side with respect to the sensor.

2. The vehicle front structure according to claim 1, wherein the air guide member is provided so as to extend from the cover member toward the vehicle rear side, and is inclined so as to be positioned downward toward the vehicle rear side when viewed from a side.

3. The vehicle front structure according to claim 1, wherein the air guide member is provided to have a width that becomes smaller toward the vehicle rear side when viewed in plan.

4. The vehicle front structure according to claim 1, further comprising a front grille provided in the opening, wherein the sensor is attached to the front grille.
